(19) United States
(12) Patent Application Publication
(10) Pub. No.: US 2025/0384243 A1
(43) Pub. Date: Dec. 18, 2025

(54) TOKEN PRUNING FOR LANGUAGE GENERATION

(71) Applicant: International Business Machines Corporation, Armonk, NY (US)

(72) Inventors: Haode Qi, Cambridge, MA (US); Cheng Qian, Toronto (CA); Gengyu Wang, Redwood City, CA (US); Sneha Srinivasan, San Jose, CA (US); Pratyush Singh, Plano, TX (US); Ladislav Kunc, Praha (CZ); Juergen Bross, New York, NY (US); Jian Ni, Millwood, NY (US); Radu Florian, Danbury, CT (US)

(21) Appl. No.: 18/742,242

(22) Filed: Jun. 13, 2024

(51) Int. Cl. G06N 3/0455; G06N 3/08

(52) U.S. Cl. CPC G06N 3/0455; G06N 3/08

(57) ABSTRACT

Embodiments of the invention provide a computer-implemented method that includes executing, using a generative language model, generative language model operations operable to generate an output sequence responsive to an original input sequence. The generative language model operations include token pruning operations that include performing a base set of token pruning operations on intermediate versions of the original input sequence; and performing token pruning (TP) constraint evaluations. The base set of token pruning operations identify pruning candidate tokens in the intermediate versions of the original input sequence. The TP constraint evaluations determine that at least one of the pruning candidate tokens will be pruned from an associated intermediate version of the original input sequence.

### BACKGROUND

The present invention relates in general to programmable computers that are used to implement generative neural networks. More specifically, the present invention relates to computing systems, computer-implemented methods, and computer program products that utilize token pruning processes in transformer-based language generation neural networks such as language models.

In its simplest form, artificial intelligence (AI) is a field that combines computer science and robust datasets to enable problem-solving. AI also encompasses sub-fields of machine learning and deep learning. Machine learning and deep learning are implemented as neural networks having input layers, hidden layers and output layers. Machine learning neural networks differ from deep learning neural networks in that deep learning has more hidden layers than machine learning. AI systems can be implemented as AI algorithms that seek to create expert systems operable to make predictions or classifications based on input data.

Natural language processing (NLP) is a branch of AI that gives machines the ability to understand natural human speech. Using linguistics, statistics, and machine learning, computers not only derive meaning from what is said or written, they can also understand contextual nuances and a speaker's or writer's intent and sentiment in substantially the same manner as humans.

Deep learning has been used extensively for perception tasks in NLP. For example, language models (LMs) can be implemented as transformer-based models that have advanced prediction and classification operations in various natural language tasks such as question answering, summarization, and language (or text) generation. Because the size of LMs can become quite large, they are often referred to as large language models (LLMs).

### SUMMARY

Embodiments of the invention provide a computer-implemented method that includes executing, using a generative language model, generative language model operations operable to generate an output sequence responsive to an original input sequence. The generative language model operations include token pruning operations that include performing a base set of token pruning operations on intermediate versions of the original input sequence; and performing token pruning (TP) constraint evaluations. The base set of token pruning operations identify pruning candidate tokens in the intermediate versions of the original input sequence. The TP constraint evaluations determine that at least one of the pruning candidate tokens will be pruned from an associated intermediate version of the original input sequence.

Embodiments of the invention are also directed to computer systems and computer program products having substantially the same features and functionality as the computer-implemented method described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2A depicts a simplified block diagram illustrating a model of a biological neuron operable to be utilized in neural network (NN) architectures in accordance with aspects of the invention;

FIG. 2B depicts a simplified block diagram illustrating a deep learning NN architecture in accordance with aspects of the invention;

FIG. 3 depicts a diagram illustrating a non-limiting example of a dimensionality reduction operation operable to utilize word embeddings in accordance with aspects of the invention;

FIG. 4A depicts a simplified block diagram illustrating a non-limiting example of a transformer NN architecture operable to implement aspects of the invention;

FIG. 4B depicts a simplified block diagram illustrating a non-limiting example of an encoder element of a transformer NN architecture operable to implement aspects of the invention;

FIG. 4C depicts a simplified block diagram illustrating a non-limiting example of a decoder element of a transformer NN architecture operable to implement aspects of the invention;

FIG. 5 depicts a non-limiting example of a language model operable to perform token pruning operations in accordance with aspects of the invention;

FIG. 6 depicts a non-limiting example of probabilistic language generation that can be used in the language model shown in FIG. 5;

FIG. 7 depicts a flow diagram illustrating a computer-implemented methodology of performing token pruning operations in accordance with aspects of the invention;

FIG. 8 an overview of a token pruning operation in accordance with aspects of the invention;

FIG. 9A depicts a non-limiting example of attention matrices used in accordance with aspects of the invention;

FIG. 9B depicts a non-limiting example of attention matrices used in accordance with aspects of the invention;

FIG. 10 depicts non-limiting examples of pruning result constraints in accordance with aspects of the invention;

FIG. 11 depicts a non-limiting example of using KV cache memory usage techniques in accordance with aspects of the invention;

FIG. 12 depicts a non-limiting example of using KV cache memory usage techniques in accordance with aspects of the invention;

FIG. 13 depicts non-limiting examples of KV cache constraints in accordance with aspects of the invention; and

FIG. 14 depicts a system for learning parameters associated with performing token pruning operations in accordance with aspects of the invention.

In the accompanying figures and following detailed description of the disclosed embodiments, the various elements illustrated in the figures are provided with three-digit reference numbers. In some instances, the leftmost digits of each reference number correspond to the figure in which its element is first illustrated.

### DETAILED DESCRIPTION

Language models (LMs) have demonstrated a range of capabilities in language understanding and generation. However, such a range of capabilities typically comes with a substantial model size, which presents significant challenges in both the deployment, inference, and training stages. For example, transformer-based LMs with attention mechanisms have a hard time scaling to long sequences with large amounts of context. In general, a longer string input requires more time to process that a shorter string input. Additionally, as the generation process continues (i.e., a next token/word in the sequence is determined or guessed). Because many LMs have limits on context size, and because LM usage fees are often based on context size, prompts with larger context are more expensive to process and may not be able to run. In general, a prompt is natural language text and associated format (e.g., a multiple choice questions format) describing the task that an AI should perform.

Embodiments of the invention improve the performance of language understanding and generation operations in LMs by providing computing systems, computer-implemented methods, and computer program products that utilize novel token pruning processes in language generation neural networks such as language models. The novel token pruning processes disclosed herein effectively and efficiently identify and remove less important tokens (or words) prior to the generation of new tokens, thereby allowing the LM's text understanding and generation processes to focus on the most relevant token/word context, which can improve the LM's accuracy and reduce the cost and number of computations required for each token/word generation operation (i.e., each “inference”).

Embodiments of the invention can be applied in transformer-based LMs that perform advanced prediction and classification operations in various natural language tasks such as question answering, summarization, and language (or text) generation. In some embodiments of the invention, the novel token pruning processes disclosed herein are applied at multiple layers of the LM transformer. In some embodiments of the invention, the token pruning processes disclosed herein are applied at every layer of the LM transformer. In some embodiments of the invention, the token pruning processes disclosed herein are applied as part of multiple inference operations of the LM transformer. In some embodiments of the invention, the token pruning processes disclosed herein are applied as part of every inference operation of the LM transformer.

In embodiments of the invention, the novel token pruning processes can include a base set of token pruning operations and a set of token pruning (TP) constraints. The base set of token pruning operations determine whether or not one or more of the sequence tokens are candidates for pruning. In some embodiments of the invention, the determination of whether or not one or sequence tokens are candidates for pruning can be based at least in part on the determination of an importance level (IL) for each token, along with the application of an IL-based selection process to identify one or more pruning candidate tokens. In some embodiments of the invention, the IL of each token is determined based on a computed attention score for each token; the IL selection process includes the determination and application of a threshold attention score for the sequence-under-evaluation; and the one or more tokens that are selected as candidates for pruning are the one or more tokens, if any, that do not meet or exceed the threshold attention score.

In embodiments of the invention, the TP constraints are configured and arranged to determine whether or not one or more of the pruning candidate tokens, as identified through the base set of token pruning operations, will in fact be pruned. In some embodiments of the invention, the TP constraints are designed to not prune a pruning candidate token in situations where pruning the pruning candidate token would have a negative impact on the token/word generation operations to be performed in a given layer of the LM transformer. In some embodiments of the invention, a TP constraint is generated in any suitable manner, including but not limited to an automated TP constraint generation system in which a second generative language model is trained to evaluate generative language operations of a first generative language model to generate a TP constraint. Non-limiting examples of TP constraints include, to provide protection against the negative results of short sentences/sequences, a token sequence with length shorter than Lₜₕᵣₑₛₕ is not pruned; to provide protection against the negative results of frequent input/output (I/O) operations, at each iteration, a token sequence will not be pruned unless the number of tokens to prune is greater than p % of the sentence/sequence length; to provide protection for original prompts (e.g., the original sentence/sequence), all tokens from the original prompt will be protected from being pruned; to provide protection for the latest tokens, the most recently generated tokens will not be pruned. In general, a prompt is natural language text and associated format (e.g., a multiple choice questions format) describing the task that an AI should perform.

Embodiments of the invention are further operable to control interactions between pruned tokens and the key and value (KV) cache used in the self-attention layers of the generative LM transformers to cache the key (K) and value (V) states of the generative LM transformer to thereby speed up inference operations. In accordance with embodiments of the invention, pruned tokens will not be added to the KV cache in future iterations of the layer-based generative language operations performed by the LM. In accordance with embodiments of the invention, most recently generated tokens will only be added to KV cache after they fall out of the most recently generated time window and they are still not pruned by then.

In accordance with embodiments of the invention, a transformer-based LM can be trained to perform the novel token pruning processes in accordance with the various features described herein using, for example, an automated artificial intelligence (Auto AI) system. In embodiments of the invention, the Auto AI system can be implemented using an “AutoAI” tool in Watson Studio® that is commercially available from IBM®. The IBM AutoAI tool automatically analyzes data and generates candidate model pipelines customized for predictive modeling problem. These model pipelines are created iteratively as AutoAI analyzes dataset and discovers data transformations, algorithms, and parameter settings that work best for the problem setting. Parameters are a machine learning term for the variables present in the model on which it was trained that can be used to infer new content. Results are displayed on a leaderboard, showing the automatically generated model pipelines ranked according to the problem optimization objective.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The components/modules of the systems illustrated herein are depicted separately for ease of illustration and explanation. In embodiments of the invention, the functions performed by the components/modules can be distributed differently than shown without departing from the scope of the various embodiments of the invention describe herein unless it is specifically stated otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

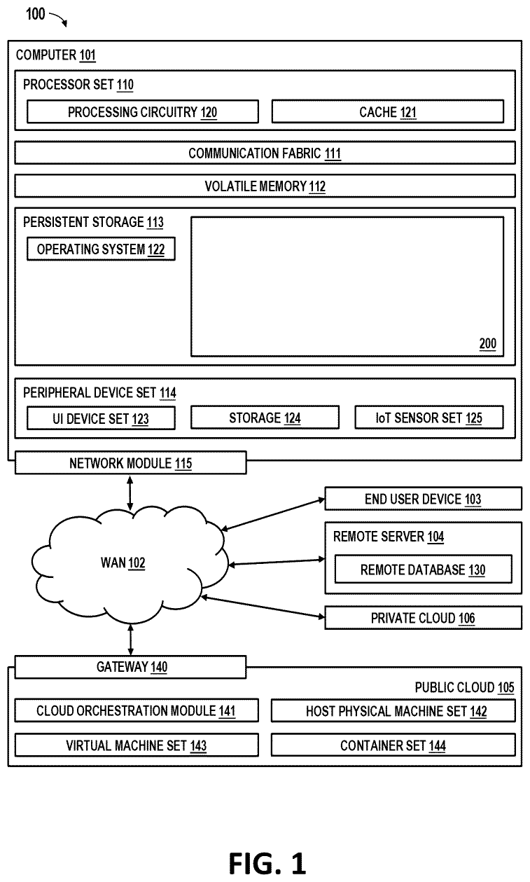

FIG. 1 depicts a computing environment 100 that contains an example of an environment for the execution of at least some of the computer code involved in performing the inventive methods, such as code block 200 operable to implement novel token pruning processes described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the invention can be implemented using NNs, which are a specific category of machines that can mimic human cognitive skills. In general, a NN is a network of artificial neurons or nodes inspired by the biological neural networks of the human brain. The artificial neurons/nodes of a NN are organized in layers and typically include input layers, hidden layers and output layers. Machine learning differ from deep learning in that deep learning has more hidden layers than machine learning. Neuromorphic and synaptronic systems, which are also referred to as artificial neural networks (ANNs), are computational systems that permit electronic systems to essentially function in a manner analogous to that of biological brains. Neuromorphic and synaptronic systems do not generally utilize the traditional digital model of manipulating zeros (0 s) and ones (1 s). Instead, neuromorphic and synaptronic systems create connections between processing elements that are roughly functionally equivalent to neurons of a biological brain. Neuromorphic and synaptronic systems can be implemented using various electronic circuits that are modeled on biological neurons.

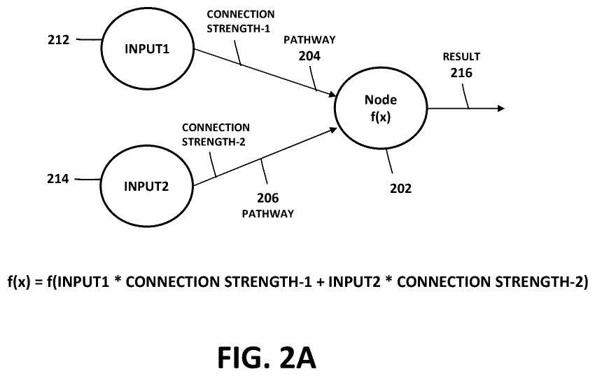

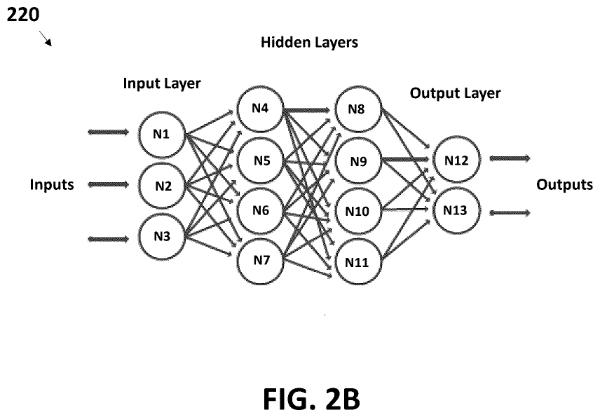

In FIG. 2A, the biological neuron is modeled as a node 202 having a mathematical function, f(x), depicted by the equation shown in FIG. 2A. Node 202 receives electrical signals from inputs 212, 214, multiplies each input 212, 214 by the strength of its respective connection pathway 204, 206, takes a sum of the inputs, passes the sum through a function, f(x), and generates a result 216, which may be a final output or an input to another node, or both. In the present specification, an asterisk (*) is used to represent a multiplication. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

FIG. 2B depicts a simplified example of a deep learning NN architecture (or model) 220. In general, NNs can be implemented as a set of algorithms running on a programmable computer (e.g., computer 101 and/or remote server 104 of the computing environment 100 shown in FIG. 1). In some instances, NNs are implemented on an electronic neuromorphic machine (e.g., the IBM®/DARPA SyNAPSE computer chip) that attempts to create connections between processing elements that are substantially the functional equivalent of the synapse connections between brain neurons. In either implementation, NNs incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a NN is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The NN is “trained” by performing multiple iterations of learning-based analysis on the real-world data vectors until patterns (or relationships) contained in the real-world data vectors are uncovered and learned.

NNs use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a NN can be used to perform a variety of tasks, two of the more common tasks are labeling (or classification) of real-world data and determining the similarity between segments of real-world data. Classification tasks often depend on the use of labeled datasets to train the NN to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, and the like. Similarity tasks apply similarity techniques and (optionally) confidence levels (CLs) to determine a numerical representation of the similarity between a pair of items.

Returning again to FIG. 2B, the simplified NN architecture/model 220 is organized as a weighted directed graph, where the artificial neurons are nodes (e.g., N1-N13), and where weighted directed edges (i.e., directional arrows) connect the nodes. The NN architecture/model 220 is organized such that nodes N1, N2, N3 are input layer nodes, nodes N4, N5, N6, N7 are first hidden layer nodes, nodes N8, N9, N10, N11 are second hidden layer nodes, and nodes N12, N13 are output layer nodes. Having multiple hidden layers indicates that the NN architecture/model 220 is a deep learning NN architecture/model. Each node is connected to every node in the adjacent layer by connection pathways, which are depicted in FIG. 2B as directional arrows each having its own connection strength. For ease of illustration and explanation, one input layer, two hidden layers, and one output layer are shown in FIG. 2B. However, in practice, multiple input layers, multiple hidden layers, and multiple output layers can be provided. When multiple hidden layers are provided, the NN model 220 can perform unsupervised deep-learning for executing classification/similarity type tasks.

Similar to the functionality of a human brain, each input layer node N1, N2, N3 of the NN 220 receives Inputs directly from a source (not shown) with no connection strength adjustments and no node summations. Each of the input layer nodes N1, N2, N3 applies its own internal f(x). Each of the first hidden layer nodes N4, N5, N6, N7 receives its inputs from all input layer nodes N1, N2, N3 according to the connection strengths associated with the relevant connection pathways. Thus, in first hidden layer node N4, its function is a weighted sum of the functions applied at input layer nodes N1, N2, N3, where the weight is the connection strength of the associated pathway into the first hidden layer node N4. A similar connection strength multiplication and node summation is performed for the remaining first hidden layer nodes N5, N6, N7, the second hidden layer nodes N8, N9, N10, N11, and the output layer nodes N12, N13.

The NN model 220 can be implemented as a feedforward NN or a recurrent NN. A feedforward NN is characterized by the direction of the flow of information between its layers. In a feedforward NN, information flow is unidirectional, which means the information in the model flows in only one direction-forward-from the input nodes, through the hidden nodes (if any) and to the output nodes, without any cycles or loops. In contrast to recurrent NNs, which have a bi-directional information flow, feedforward NNs are trained using the backpropagation method.

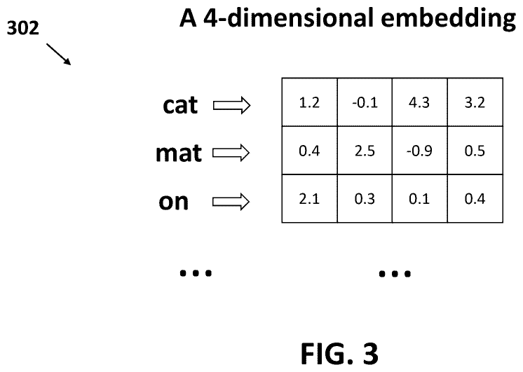

Some embodiments of the invention utilize and leverage embedding spaces. An embedding is a relatively low-dimensional space into which high-dimensional vectors can be translated. Embeddings make it easier to apply machine learning to large inputs like sparse vectors representing words. FIG. 3 illustrates the concept of embedding using an example word embedding 302. In general, NN models take vectors (i.e., an array of numbers) as inputs. Where the inputs are natural language symbols, token/word vectorization refers to techniques that extract information from the natural language symbol corpus and associate to each word of the natural language symbol corpus a vector using a suitable vectorization algorithm that takes into account the word's context.

Word embeddings are typically a low-dimensional dense vector-based space where the semantically similar words are placed closely together. In general, an embedding is a dense vector of floating-point values. In a word embedding, words are represented by dense vectors where a vector represents the projection of the word into a continuous vector space. The dimension of the vector is a parameter that must be specified. However, the values of the embeddings are trainable parameters (i.e., weights learned by the model during training in the same way a model learns weights for a dense layer). More specifically, the position of a word within the vector space of an embedding is learned from text in the relevant language domain and is based on the words that surround the word when it is used. The position of a word in the learned vector space of the word embedding is referred to as its embedding.

FIG. 3 depicts an example diagram of a word embedding 302 in an English language domain. As shown in FIG. 3, each word is represented as a 4-dimensional vector of floating-point values. Another way to think of the word embedding 302 is as a “lookup table.” After the weights have been learned, each word can be encoded by looking up the dense vector it corresponds to in the table. The embedding layer (or lookup table) maps from integer indices (which stand for specific words) to dense vectors (their embeddings). The dimensionality (or width) of the embedding is a parameter that can be selected to match the task for which it is designed. When an embedding layer is created, the weights for the embeddings are randomly initialized (just like any other layer). During training, the weights are gradually adjusted via back-propagation training techniques. Once trained, the learned word embeddings will roughly encode similarities between words (as they were learned for the specific problem on which the model is trained). The general techniques used in word embedding apply to embeddings in other domains, including domains used in embodiments of the invention.

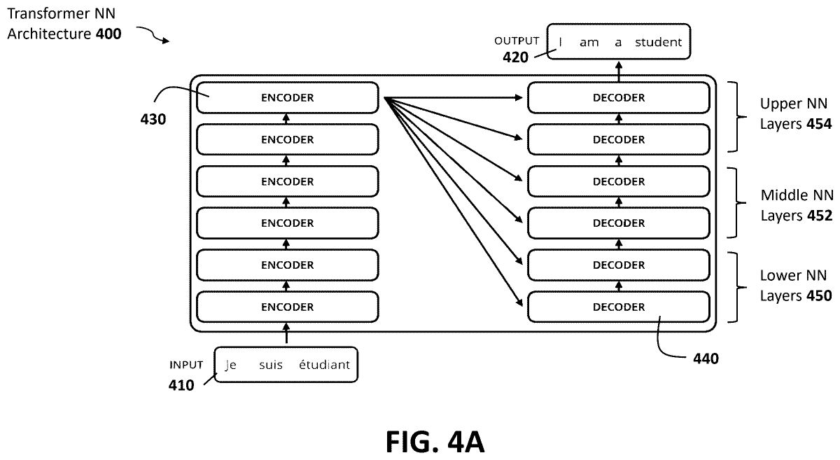

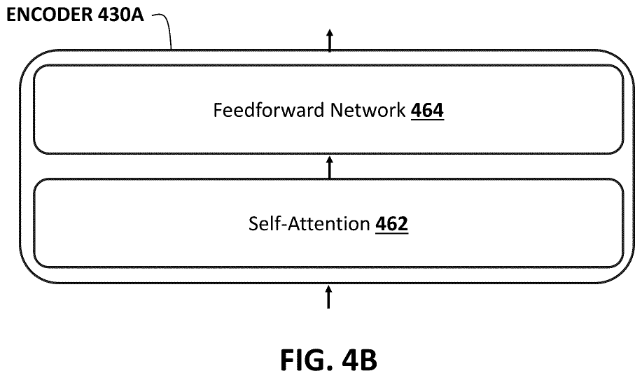

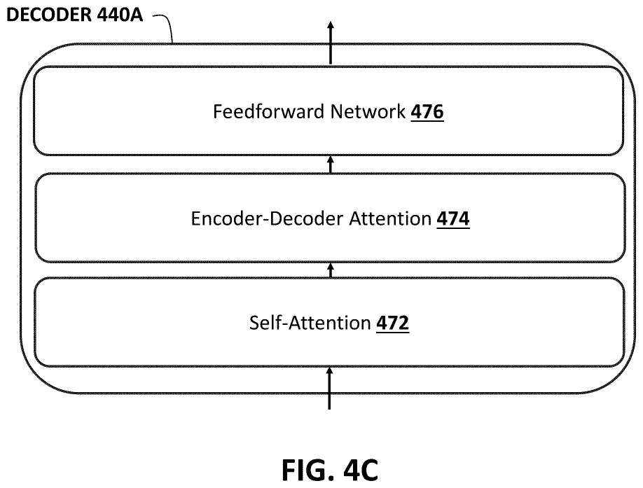

FIGS. 4A, 4B and 4C depict a non-limiting example of various aspects of a transformer NN architecture 400 that can be utilized to implement some aspects of the invention. More specifically, FIG. 4A depicts a simplified block diagram illustrating a non-limiting example of the transformer NN architecture 400; FIG. 4B depicts a simplified block diagram illustrating a non-limiting example of an encoder 430A of the transformer NN architecture 400; and FIG. 4C depicts a simplified block diagram illustrating a non-limiting example of a decoder 440A of the transformer NN architecture 400.

The transformer NN architecture 400 includes tokenization and embedding features. In embodiments of the invention, the transformer NN architecture 400 converts text and other data to vectors and back using tokenization, positional encoding, and embedding layers. Tokenization is the process of splitting a phrase, sentence, paragraph, one or multiple text documents into smaller units. Each of these smaller units is called a token. In general, tokens can be anything, including, for example, a word, a sub-word, or even a character. Multiple types of algorithms are available for performing tokenization. The transformer NN architecture 400 is a sequence-to-sequence NN architecture in which input text is encoded with tokenizers to sequences of integers called input tokens. Input tokens are mapped to sequences of vectors (e.g., word embeddings) via embeddings layers. Output vectors (embeddings) can be classified to a sequence of tokens, and output tokens can then be decoded back to text.

More generally, tokenization is cutting input data into parts (symbols) that can be mapped (embedded) into a vector space. For example, input text is split into frequent words, which is an example of transformer tokenization. Tokenization used in transformer-based NLP models can be sub-word tokenizers. The resulting tokens can be both words or “sub-words” In some instances, special tokens can be appended to the sequence (e.g., class tokens) used for classification embeddings. Positional encodings add token order information. Self-attention and feed-forward layers are symmetrical with respect to the input so positional information is provided about each input token so positional encodings or embeddings are added to token embeddings in transformer encodings. Accordingly, embeddings are learned and/or trained.

As shown in FIG. 4A, the transformer NN architecture 400 includes a series or sequence of encoders 430 and a sequence of decoders 440 configured and arranged as shown. The encoders 430 and decoders 440 are organized around groups of layers including lower NN layers 450, middle NN layers 452, and upper NN layers 454. The transformer NN architecture 400 receives an input 410 (e.g., a sentence in French), uses the encoders 430 and the decoders 440 to perform a task (e.g., translating a French sentence to an English sentence), and, responsive to the input 410 generates an output 420 (e.g., an English translation of a French sentence). More specifically, the encoders 430 are configured and arranged to take the input 410, for example a sentence (i.e., sequences) written in French, and mapping it to high-dimensional representation(s). The encoders 430 are configured to “learn” the parts of the input 410 (i.e., the sequence) that are important and pass them to the high-dimensional representation, and the less-important aspects of the input 410 (e.g., the sequence) are left out. At this stage, the high-dimensional representation cannot be easily understood because there are no semantics involved and the complete mapping has not yet been learned.

The decoders 440 are configured to convert the high-dimensional representation into the output 420, which, in this example, is a sequence (e.g., a sequence written in English). Utilizing the encoders 430 and the decoders 440 allows models to be built that can transduce (i.e., map without losing semantics) “one way” into “another,” e.g., French into English. By training the encoders 430 and the decoders 440 together, a sequence-to-sequence model is created. A sequence-to-sequence model is capable of ingesting a sequence of a particular kind and outputting another sequence of another kind.

In embodiments of the invention, the transformer NN architecture 400 (also known as a generative language model) can be trained to perform the various tasks described herein. In the transformer NN architecture 400, the encoders 430 can be organized in layers (e.g., lower NN layers 450, middle NN layers 452, and upper NN layers 454) that process the input 410 iteratively one layer after another; and the decoders 440 can also be organized in corresponding layers (e.g., lower NN layers 450, middle NN layers 452, and upper NN layers 454) that do the same thing to the output of the last encoder 430. The function of each encoder 430 in a given layer is to process its input to generate encodings that contain information about which parts of the inputs are relevant to each other. The encoder 430 in one layer passes its set of encodings to the encoder 430 in the next layer as inputs. Each decoder 440 in a corresponding layer does the opposite, taking the output from the last encoder 430 and processing them, using their incorporated contextual information, to generate the output 420. To achieve this, each encoder 430 of a given layer makes use of an attention mechanism (e.g., self-attention 462 shown in FIG. 4B). In the context of NNs, an attention mechanism is a technique that electronically mimics human cognitive attention. The effect enhances the important parts of the input data and fades out the rest such that the NN devotes more computing power on that small but important part of the data. The part of the data that is more important than other parts of the data depends on the context and is learned through training data by gradient descent. Thus, the attention mechanism of the transformer NN architecture 400 weighs the relevance of every other input and draws information from them accordingly to produce the output. Each decoder 440 can include an additional attention mechanism (e.g., self-attention 472 and encoder-decoder attention 474 shown in FIG. 4C) that draws information from the outputs of previous decoders 440 before the current decoder 440 draws information from the encodings. The encoders 430 and the decoders 440 each include a feedforward network (e.g., feedforward network 464 shown in FIG. 4B, and feedforward network 476 shown in FIG. 4C) for additional processing of the outputs, and also contain residual connections and layer normalization steps.

FIG. 4B depicts a simplified block diagram illustrating a non-limiting example of how the encoder 430 (shown in FIG. 4A) can be implemented as the encoder 430A; and FIG. 4C depicts a simplified block diagram illustrating a non-limiting example of how the decoder 440 (shown in FIG. 4A) can be implemented as the decoder 440A. The encoders 430 are very similar to each other, and the decoders 440 are very similar to each other, as well. As shown in FIG. 4B, each encoder 430A includes two sub-layers, namely, a self-attention 462 and a feedforward network 464. The inputs to the encoder 430A first flow through the self-attention 462, which helps the encoder 430A look at other parts of the input 410 as it encodes a specific word. The decoder 440A shown in FIG. 4C has a corresponding self-attention 472 and feedforward network 476 that perform substantially the same functions in the decoder 440A as the self-attention 462 and the feedforward network 464 perform in the encoder 430A. The decoder 440A further includes encoder-decoder attention 474 that helps the decoder 440A focus on relevant parts of the input sentence.

Turning now to a more detailed description of aspects of the invention, embodiments of the invention provide a computer-implemented method that includes executing, using a generative language model, generative language model operations operable to generate an output sequence responsive to an original input sequence. As used herein, the term “executing” refers to a computing system (e.g., computing environment 100 shown in FIG. 1) loading and reading a set of electronic program instructions in order for the computer system to perform a task or operation The generative language model operations include token pruning operations that include performing a base set of token pruning operations on intermediate versions of the original input sequence; and performing token pruning (TP) constraint evaluations. The base set of token pruning operations identify pruning candidate tokens in the intermediate versions of the original input sequence. The TP constraint evaluations determine that at least one of the pruning candidate tokens will be pruned from an associated intermediate version of the original input sequence.

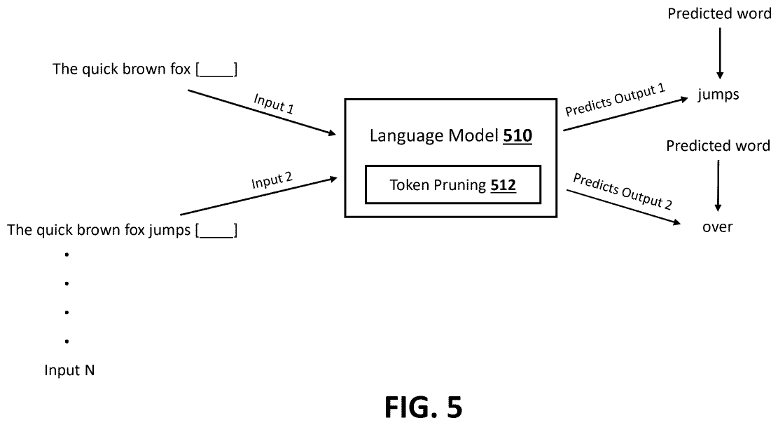

FIG. 5 depicts a simplified block diagram illustrating a non-limiting example of a LM 510 operable to implement token pruning processes 512 in accordance with embodiments of the invention. In embodiments of the invention, the LM 510 is a generative transformer-based LM operable to perform advanced prediction and classification operations in various natural language tasks such as question answering, summarization, and language (or text) generation. In some embodiments of the invention, the LM 510 can be sufficiently large to qualify as a large language model (LLM). An evolution of language models is LLMs, which dramatically expand the data used for training and inference, and which provide a massive increase in the capabilities of the resulting model. While there is no universally accepted figure for how large the data set for training needs to be, an LLM typically has about one billion or more parameters. Parameters are a machine learning term for the variables present in the model on which it was trained that can be used to infer new content. An LLM uses deep learning techniques and massively large data sets to understand, summarize, generate and predict new content. The term generative AI also is closely connected with LMs and/or LLMs, which are a type of generative AI that has been specifically architected to help generate language-based content.

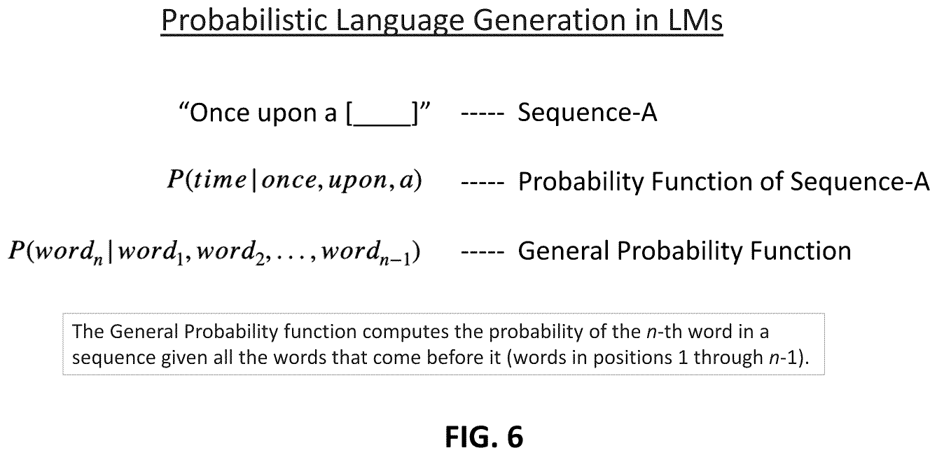

A non-limiting example of generative text operations that can be performed by the LM 510 is illustrated in FIG. 5. As shown, Input 1 is a sequence of tokens that form a segment of a sentence, and the LM 510 has been trained to predict the next word in the sentence segment, or, when the sentence is complete, predict the next sentence in the overall text. The LM 510 uses, for example, the encoder-decoder and self-attention functionality of the transformer NN architecture 400 (shown in FIGS. 4A, 4B, 4C) to predict Output 1, which is a prediction that the next token/word in Input 1 is “jumps.” The encoder-decoder and self-attention functionality of the transformer NN architecture 400 performs various forms of probabilistic language generation, an example of which is the general probability function, P(wordₙ|word₁, word₂, . . . , wordₙ₋₁), shown in FIG. 6. The general probability function computes the probability of the n-th word in a sequence given all the words that come before it (words in positions 1 through n-1). Continuing with FIG. 5, the LM 510 appends the predicted word “jumps” to Input 1 to generate Input 2, and Input 2 is provided to the LM 510, which then uses Input 2 to predict Output 2, which is a prediction that the next token/word in Input 2 is “over.” This process of predicting next words continues until the desired text content is complete (i.e., Input N).

There are various suitable implementations of the LM 510, and such implementations have demonstrated a range of capabilities in language understanding and generation. However, such a range of capabilities typically comes with a substantial model size, which presents significant challenges in both the deployment, inference, and training stages. For example, transformer-based implementations of the LM 510 with attention mechanisms have a hard time scaling to long sequences with large amounts of context. In general, a longer string input requires more time to process that a shorter string input. Additionally, as the generation process continues (i.e., a next token/word in the sequence is determined, predicted, or guessed). Because many implementations of the LM 510 have limits on context size, and because LM usage fees are often based on context size, prompts with larger context are more expensive to process and may not be able to run. In general, a prompt is natural language text and associated format (e.g., a multiple choice questions format) describing the task that an AI should perform.

Embodiments of the invention improve the performance of language understanding and generation operations in the LM 510 by providing computing systems, computer-implemented methods, and computer program products that utilize novel token pruning processes 512 in the language generation operations performed by the LM 510. The novel token pruning processes 512 effectively and efficiently identify and remove less important tokens (or words) prior to the LM 510 generating new tokens (e.g., Output 1, Output 2, shown in FIG. 5), thereby allowing the text understanding and generation processes performed by the LM 510 to focus on the most relevant token/word context, which can improve the accuracy of the LM 510, as well as reducing the cost and number of computations required for each token/word generation operation (i.e., each “inference”) performed by the LM 510.

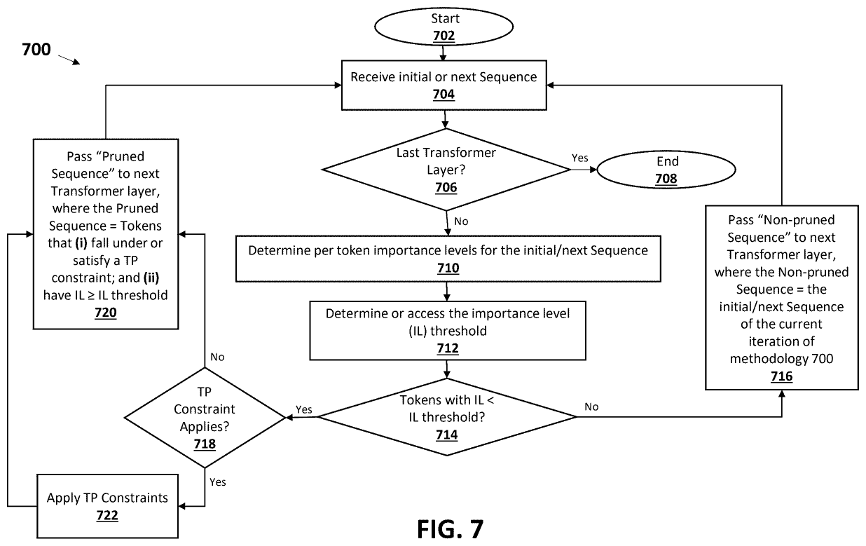

FIG. 7 depicts a non-limiting example of how the novel token pruning processes 512 can be implemented as a computer-implemented methodology 700 in accordance with embodiments of the invention. With reference now to both FIG. 6 and FIG. 7, and as an overview of the novel token pruning processes 512 and the methodology 700, in some embodiments of the invention, the LM 510 is transformer-based and performs advanced prediction and classification operations in various natural language tasks such as question answering, summarization, and language (or text) generation. In some embodiments of the invention, the novel token pruning processes 512 and methodology 700 are applied at multiple layers of the transformer-based implementation of the LM 510. In some embodiments of the invention, the token pruning processes 512 and the methodology 700 are applied at every layer of the transformer-based implementation of the LM 510. In some embodiments of the invention, the token pruning processes 512 and the methodology 700 are applied as part of multiple inference operations of the transformer-based implementation of the LM 510. In some embodiments of the invention, the token pruning processes 512 and the methodology 700 are applied as part of every inference operation of the transformer-based implementation of the LM 510.

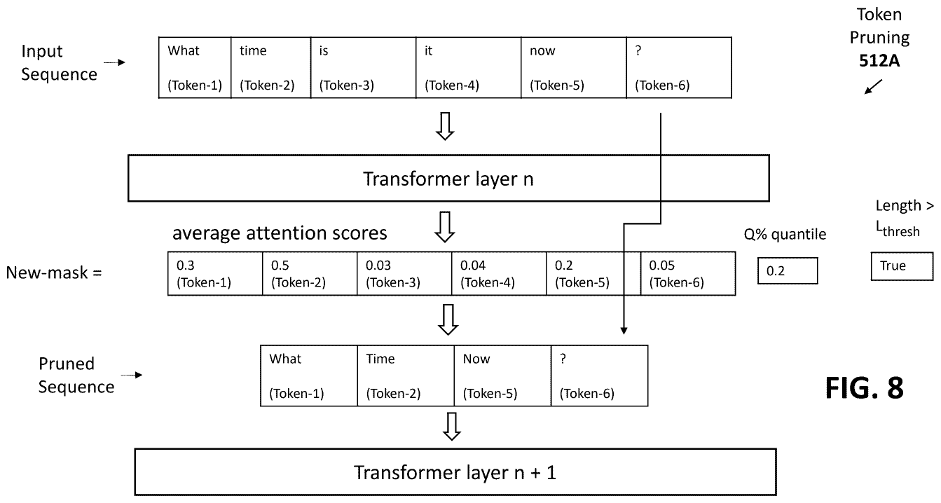

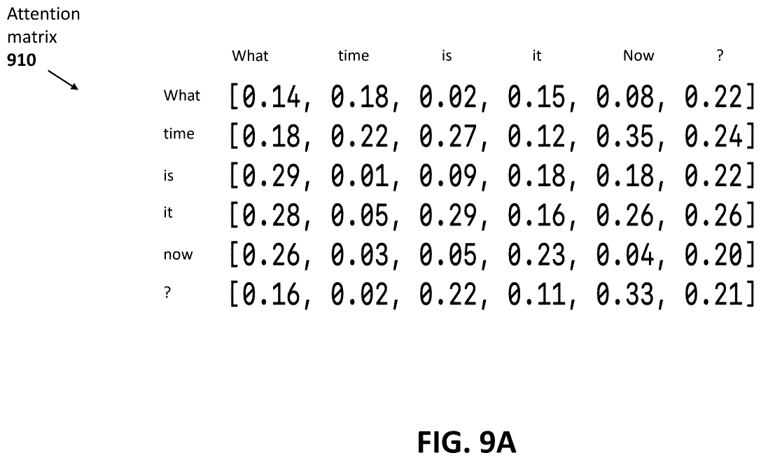

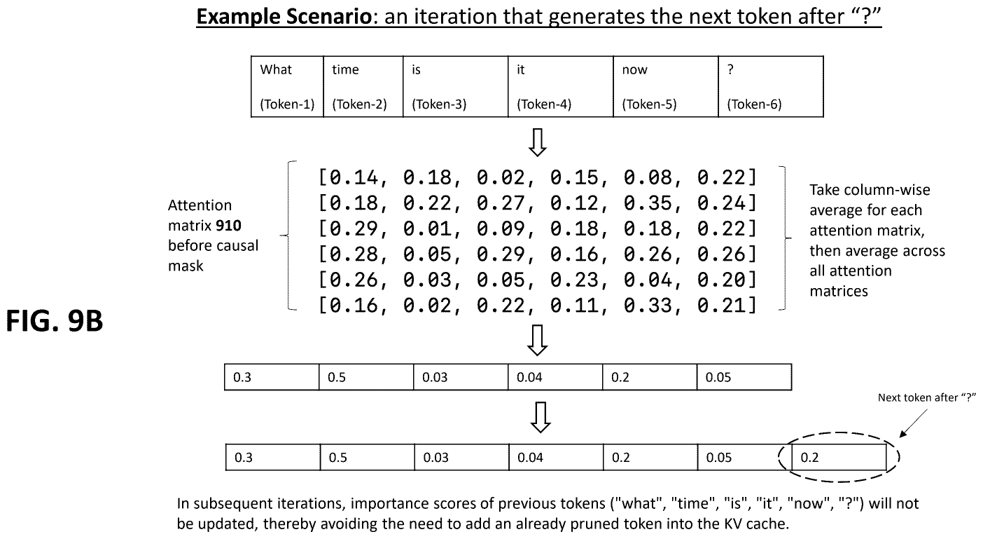

In embodiments of the invention, the novel token pruning processes 512 and the methodology 700 can include a base set of token pruning operations (e.g., blocks 710, 712, 714 of the methodology 700) and a set of token pruning (TP) constraints (e.g., decision block 718 of the methodology 700). The base set of token pruning operations determine whether or not one or more of the sequence tokens are candidates for pruning (e.g., a yes response at decision block 714 of the methodology 700). In some embodiments of the invention, the determination of whether or not one or sequence tokens are candidates for pruning can be based at least in part on the determination of an importance level (IL) for each token, along with the application of an IL-based selection process to identify one or more pruning candidate tokens. In some embodiments of the invention, the IL of each token is determined based on a computed attention score for each token (e.g., FIGS. 8, 9A and 9B); the IL selection process includes the determination and application of a threshold attention score for the sequence-under-evaluation; and the one or more tokens that are selected as candidates for pruning are the one or more tokens, if any, that do not meet or exceed the threshold attention score.

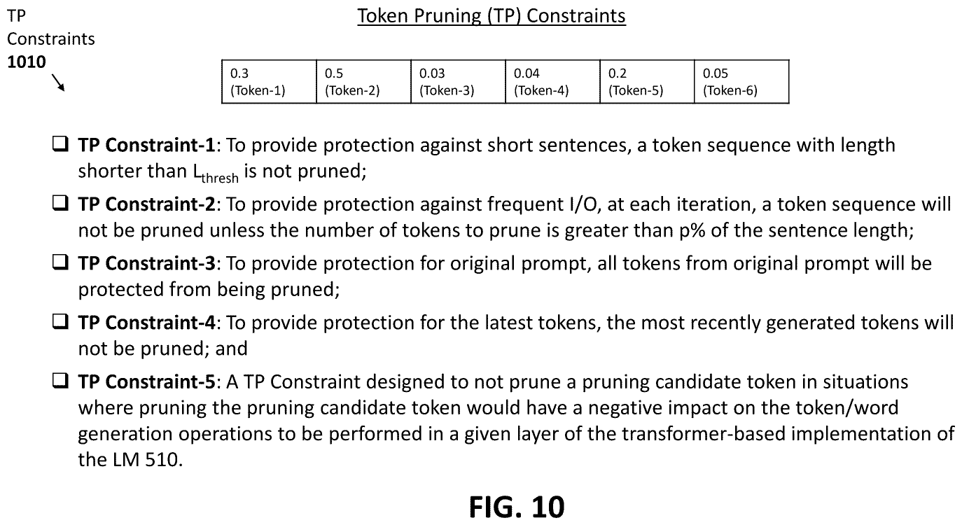

In embodiments of the invention, the TP constraints (e.g., decision block 718 of the methodology 700; and FIG. 10) are configured and arranged to determine whether or not one or more of the pruning candidate tokens, as identified through the base set of token pruning operations, will in fact be pruned. In some embodiments of the invention, the TP constraints are designed to not prune a pruning candidate token in situations where pruning the pruning candidate token would have a negative impact on the token/word generation operations to be performed in a given layer of the LM transformer. In some embodiments of the invention, a TP constraint is generated in any suitable manner, including but not limited to an automated TP constraint generation system in which a second generative language model is trained to evaluate generative language operations of a first generative language model to generate a TP constraint. In some embodiments of the invention, the first and second generative language models can be incorporated within the LM 510. Non-limiting examples of TP constraints include, to provide protection against the negative results of short sentences/sequences, a token sequence with length shorter than Lthresh is not pruned; to provide protection against the negative results of frequent input/output (I/O) operations, at each iteration, a token sequence will not be pruned unless the number of tokens to prune is greater than p % of the sentence/sequence length; to provide protection for original prompts (e.g., the original sentence/sequence), all tokens from the original prompt will be protected from being pruned; to provide protection for the latest tokens, the most recently generated tokens will not be pruned. In general, a prompt is natural language text and associated format (e.g., a multiple choice questions format) describing the task that an AI should perform.

In embodiments of the invention, the novel token pruning processes 512 and the methodology 700 are further operable to control interactions between pruned tokens and the KV cache used in the self-attention layers of the transformer-based implementation of the LM 510 to cache the key (K) and value (V) states of the transformer-based implementation of the LM 510 to thereby speed up inference operations. In accordance with embodiments of the invention, the TP constraints can include a constraint that the pruned tokens will not be added to the KV cache in future iterations of the layer-based generative language operations performed by the LM 510. In accordance with embodiments of the invention, most recently generated tokens will only be added to KV cache after they fall out of the most recently generated time window and they are still not pruned by then.

In accordance with embodiments of the invention, the transformer-based implementation of the LM 510 can be trained to perform the novel token pruning processes in accordance with the various features described herein using, for example, an automated artificial intelligence (Auto AI) system (e.g., as shown in FIG. 15). In embodiments of the invention, the Auto AI system can be implemented using an “AutoAI” tool in Watson Studio® that is commercially available from IBM®. The IBM AutoAI tool automatically analyzes data and generates candidate model pipelines customized for predictive modeling problem. These model pipelines are created iteratively as AutoAI analyzes dataset and discovers data transformations, algorithms, and parameter settings that work best for the problem setting. Parameters are a machine learning term for the variables present in the model on which it was trained that can be used to infer new content. Results are displayed on a leaderboard, showing the automatically generated model pipelines ranked according to the problem optimization objective.

The computer-implemented methodology 700 will now be described in more detail with specific reference to FIG. 7. In the description of the methodology 700, the novel token pruning processes 512 will be described as the token pruning module 512 operable to implement the computer-implemented methodology 700. The methodology 700 begins at block 702 then moves to block 704 where the LM 510 receives at a transformer layer of the LM 510 an initial or next sequence of tokens/words. The methodology 700 moves to decision block 706 to determine whether or not the current transformer layer that received the initial or next sequence of tokens/words at block 704 is the last transformer layer. If the answer to the inquiry at decision block 706 is yes, the methodology 700 moves to block 708 and ends. If the answer to the inquiry at decision block 706 is no, the methodology 700 moves to block 710 and determines the per token IL for the initial/next sequence. The methodology 700 moves to block 712 and determines or accesses the IL threshold such that ILs below the IL threshold represent tokens that are candidates for pruning, and ILs at or above the IL threshold represent tokens that are not candidates for pruning. At decision block 714, the methodology 700 determines whether or not there are any tokens that are candidates for pruning, where the tokens that are candidates for pruning are tokens having an IL that is less than the IL threshold. In some embodiments of the invention, the IL of each token is determined at block 710 based on a computed attention score for each token (e.g., FIGS. 8, 9A and 9B); the IL determination/access process performed at block 712 includes the determination and application of a threshold attention score for the sequence-under-evaluation; and the one or more tokens that are selected at decision block 714 as candidates for pruning are the one or more tokens, if any, that do not meet or exceed the threshold attention score.

If the answer to the inquiry at decision block 714 is no, all of the tokens are sufficiently important that no pruning candidate tokens are identified; the methodology 700 moves to block 716; and block 716 passes a “Non-pruned Sequence” to the next transformer layer of the LM 510, where the Non-pruned Sequence includes the initial/next Sequence of the current iteration of the methodology 700. If the answer to the inquiry at decision block 714 is yes, one or more of the tokens evaluated at decision block 714 are sufficiently unimportant (i.e., the token's IL is less than the IL threshold) that they are identified by the methodology 700 as pruning candidate tokens, and decision block 714 passes both the pruning candidate tokens and non-pruning candidate tokens to decision block 718.

At decision block 718, the methodology 700 determines whether or not various TP constraints apply to the pruning candidate tokens identified at decision block 714. In embodiments of the invention, the TP constraints are configured and arranged to determine whether or not one or more of the pruning candidate tokens, as identified through the base set of token pruning operations, will in fact be pruned. In some embodiments of the invention, the TP constraints are designed to not prune a pruning candidate token in situations where pruning the pruning candidate token would have a negative impact on the token/word generation operations to be performed in a given layer of the transformer-based LM 510. In some embodiments of the invention, a TP constraint is generated in any suitable manner, including but not limited to an automated TP constraint generation system in which a second generative language model is trained to evaluate generative language operations of a first generative language model to generate a TP constraint. In some embodiments of the invention, the first and second generative language models can be incorporated within the LM 510. Non-limiting examples of TP constraints include, to provide protection against the negative results of short sentences/sequences, a token sequence with length shorter than Lthresh is not pruned; to provide protection against the negative results of frequent input/output (I/O) operations, at each iteration, a token sequence will not be pruned unless the number of tokens to prune is greater than p % of the sentence/sequence length; to provide protection for original prompts (e.g., the original sentence/sequence), all tokens from the original prompt will be protected from being pruned; to provide protection for the latest tokens, the most recently generated tokens will not be pruned. In general, a prompt is natural language text and associated format (e.g., a multiple choice questions format) describing the task that an AI should perform.

If the answer to the inquiry at decision block 718 is no, none of the TP constraints are applicable to the pruning candidate tokens; the methodology 700 through decision block 718 determines that all of the pruning candidate tokens identified at decision block 714 should be pruned; and only the non-pruning candidate tokens (i.e., tokens with IL<the IL threshold) are passed to block 720. If the answer to the inquiry at decision block 718 is yes, the methodology 700 moves to block 722 and applies the applicable TP constraints to their corresponding tokens. Based on the answer to the inquiry at decision block 718 being yes, at least one of the pruning candidate tokens falls under a TP constraint and therefore will not be pruned despite having an IL that is below the IL threshold. Similarly, based on the answer to the inquiry at decision block 718 being yes, some or all of the pruning candidate tokens falls under a TP constraint and therefore will not be pruned despite having an IL that is below the IL threshold. Subsequent to the operations at block 722, the methodology 700 moves to block 720, and block 720 passes a Pruned Sequence to the next transformer layer of the LM 510, where the Pruned Sequence includes the tokens that have an IL below the IL threshold but nonetheless fall under or satisfy a TP constraint, along with tokens that were determined at decision block 714 to have an IL at or above the IL threshold. From block 720, the methodology 700 returns to block 704 to access a next Sequence and perform another iteration of the methodology 700.

FIG. 8 depicts a non-limiting example that provides another view of how portions of the token pruning processes 512 (shown in FIG. 5) can be implemented as a token pruning process 512A. The token pruning process 512A is operating in a transformer-based implementation of the LM 510. The “Input Sequence” shown in FIG. 8 corresponds to Input 1 shown in FIG. 5, and, similar to the example depicted in FIG. 5, the LM 510 is tasked with making a probabilistic determination of the next token/word in the Input Sequence by passing the Input Sequence through the multiple encoder, decoder and self-attention layers of the transformer architecture (e.g., transformer architecture 400 shown in FIGS. 4A, 4B, 4C) used to implement the LM 510. Without benefit of the present invention, the entire Input Sequence would be passed from “Transformer layer n” to “Transformer layer n+1.” The token pruning processes 512A are operable to efficiently and effectively prune tokens from the Input Sequence (e.g., using the previously-described base set of token pruning operations (e.g., blocks 710, 712, 714 of the methodology 700) and a set of token pruning (TP) constraints (e.g., decision block 718 of the methodology 700)) to generate a “Pruned Sequence” and provide the Pruned Sequence to Transformer layer n+1. More specifically, the Input Sequence includes six (6) tokens labeled in FIG. 8 as Token-1, Token-2, Token-3, Token-4, Token-5, Token-6; and the Pruned Sequence has been pruned to include the four (4) tokens Token-1, Token-2, Token-5, and Token-6.

The operations at blocks 710, 712, 714, 718, 722 of the methodology 700 (shown in FIG. 7) are used to generate the Pruned Sequence from the Input Sequence. However, in the example depicted in FIG. 8, the importance level (IL) is determined based on attention scores (i.e., the “average attention scores” shown in FIG. 8) associated with each of the six (6) tokens of the Input Sequence, which are labeled in FIG. 8 as Token-1, Token-2, Token-3, Token-4, Token-5, Token-6.

In transformer-based LMs, attention scores are part of the operations of the self-attention function of the transformer architecture (e.g., self-attention layers 462, 472 shown in FIGS. 4B, 4C). Self-attention is a mechanism used in machine learning, particularly in natural language processing (NLP) and computer vision tasks, to capture dependencies and relationships within input sequences. Self-attention allows the model to identify and weigh the importance of different parts of the input sequence by attending to itself. Self-attention operates by transforming the input sequence into three vectors- namely, query (Q), key (K), and value (V). These vectors are obtained through linear transformations of the input sequence. The attention mechanism calculates a weighted sum of the values based on the similarity between the query and key vectors. The resulting weighted sum, along with the original input sequence, is then passed through a feed-forward neural network to produce the final output. This process allows the model to focus on relevant information and capture long-range dependencies.

The “average attention scores” shown in FIG. 8 can be generated based on one or more instance of the attention matrix 910 shown in FIGS. 9A, 9B. As best shown in FIG. 9A, taking the leftmost column as an example, the row entries under the leftmost column identify the attention score (i.e., the relevance) of the token/word “What” to each of the tokens/words in the Input Sequence. Thus, the relevance of “What” to “What” is 0.14; the relevance of “What” to “time” is 0.18; the relevance of “What” to “is” is 0.29; the relevance of “What” to “it” is 0.28; the relevance of “What” to “now” is 0.26; and the relevance of “What” to “?” is 0.16. The “average attention score” for the token “What” shown in FIG. 8 is the average of the row entries under the leftmost column (i.e., the “What” column) of the attention matrix 910.

In a transformer-based implementation of the LM 510, the transformer architecture can utilize a “multi-headed” self-attention mechanism (e.g., self-attention mechanisms 462, 472 shown in FIGS. 4B, 4C). Each head of the multi-headed” self-attention mechanism produces one (1) attention matrix and therefore its own attention scores. FIG. 9A is an example of one such attention matrix 910, and there will be multiple of these. Thus, in the “multi-headed” self-attention mechanism, averages of the attentions scores within each instance of the matrix 910 are computed using the methodology described above, and then the average across the corresponding results from the matrices associated with each of the “multi-headed” self-attention mechanism is computed.

As shown in FIG. 9B, after taking the column-wise average for each attention matrix 910, an average can be generated across all attention matrices to arrive at each token's average attention score. As further shown in FIG. 9B, in subsequent iterations, importance scores of previous tokens (“what,” “time,” “is,” “it,” “now,” “?”) will not be updated, thereby avoiding the need to add an already pruned token into the KV cache.

The attention score threshold for identifying pruning candidate tokens in the Input Sequence can be determined using any suitable method. In some embodiments of the invention, a heuristic method is used to develop an attention score threshold for identifying pruning candidate tokens in the Input Sequence. In the non-limiting example depicted in FIGS. 8, a suitable heuristic method has been used to generate the attention score threshold at a Q % quantile of 0.2. Thus, any token having an attention score greater than or equal to 0.2 is maintained in the text generation process performed by the LM 510, and any token having an attention score less than 0.2 is identified as a pruning candidate token. In general, quantiles are values that split sorted data or a probability distribution into equal parts. In general terms, a q-quantile divides sorted data into q parts. A heuristic method is an approach to problem-solving in which the objective is to produce a working solution within a reasonable time frame. Instead of looking for a perfect solution, heuristic strategies look for a quick solution that falls within an acceptable range of accuracy. Heuristics are used in machine learning (ML) and artificial intelligence (AI) when it is impractical to solve a particular problem with a step-by-step algorithm. Because a heuristic approach emphasizes speed over accuracy, it can be combined with optimization algorithms to improve results. Successive iterations are interdependent, and each level of a deep neural network decides which avenues to choose and discard, based on their proximity to the desired solution. In this context, the term heuristic is sometimes used as a synonym for “short-cut” because this approach to problem-solving does not waste time on things that are not likely to produce acceptable results. Heuristic methods use available data, rather than predefined solutions, to solve machine and human problems. Heuristic solutions are not necessarily provable or accurate, but they are usually good enough to solve small-scale issues that are part of a larger problem.

Referring again to FIGS. 7 and 8, as well as FIG. 10, the operations at blocks 718, 722 of the methodology 700 (shown in FIG. 7) are used to determine whether generate the determine whether TP constraints 1010 (shown in FIG. 10) apply to the pruning candidate tokens identified initially as Token-1, Token-2, and Token-5 (shown in FIG. 8 as part of the Pruned Sequence). In embodiments of the invention, the TP constraints 1010 are configured and arranged to determine whether or not one or more of the pruning candidate tokens, as identified through the base set of token pruning operations (e.g., blocks 710, 712, 714 of the methodology 700 shown in FIG. 7), will in fact be pruned. In some embodiments of the invention, the TP constraints 1010 are designed to not prune a pruning candidate token in situations where pruning the pruning candidate token would have a negative impact on the token/word generation operations to be performed in a given layer of the transformer-based implementation of the LM 510 (shown in FIG. 5). In some embodiments of the invention, a TP constraint 1010 is generated in any suitable manner, including but not limited to an automated TP constraint generation system in which a second generative language model is trained to evaluate generative language operations of a first generative language model to generate a TP constraint. In some embodiments of the invention, the first and second generative language models can be incorporated within the LM 510.

FIG. 10 depicts non-limiting examples of TP constraints 1010, which are labeled in FIG. 10 as TP Constraint-1, TP Constraint-2, TP Constraint-3, TP Constraint-4, and TP Constraint-5. Non-limiting examples of TP constraints include, TP Constraint-1, to provide protection against short sentences, a token sequence with length shorter than Lₜₕᵣₑₛₕ is not pruned; TP Constraint-2, to provide protection against frequent I/O, at each iteration, a token sequence will not be pruned unless the number of tokens to prune is greater than p % of the sentence length; TP Constraint-3, to provide protection for original prompt, all tokens from original prompt will be protected from being pruned; TP Constraint-4, to provide protection for the latest tokens, the most recently generated tokens will not be pruned; and TP Constraint-5, any TP constraint designed to not prune a pruning candidate token in situations where pruning the pruning candidate token would have a negative impact on the token/word generation operations to be performed in a given layer of the transformer-based implementation of the LM 510.

Returning to FIG. 8, two example TP constraints are depicted. A first TP constraint does not prune Token-6 (the “?”) despite Token-6 having an attention score below the attention score threshold (e.g., “0.2” shown in FIG. 8) because it is likely that, if Token-6, as a punction mark, is pruned, it is likely that the predicted next word (e.g., the “Predicted word” shown in FIG. 5) generated by the LM 510 will be the same punctuation mark that was pruned. To avoid the inefficiency that results from pruning a token that is likely to be added back by the generative tasks performed by the LM 510, the token that is likely to be added back by the generative tasks performed by the LM 510 is not pruned despite the token having an attention score below the attention score threshold (e.g., “0.2” shown in FIG. 8).

A second TP constraint depicted in FIG. 8 does not prune a “short” Input Sequence by evaluating whether the “Length” of the Input Sequence is greater than Lₜₕᵣₑₛₕ. In the example depicted in FIG. 8, the evaluation of whether Length is greater than Lₜₕᵣₑₛₕ is “True,” so the Input Sequence example depicted in FIG. 8 satisfies this constraint and can be pruned. However, if the evaluation of whether Length is greater than Lₜₕᵣₑₛₕ is “False,” the Input Sequence does not satisfy this constraint and cannot be pruned.

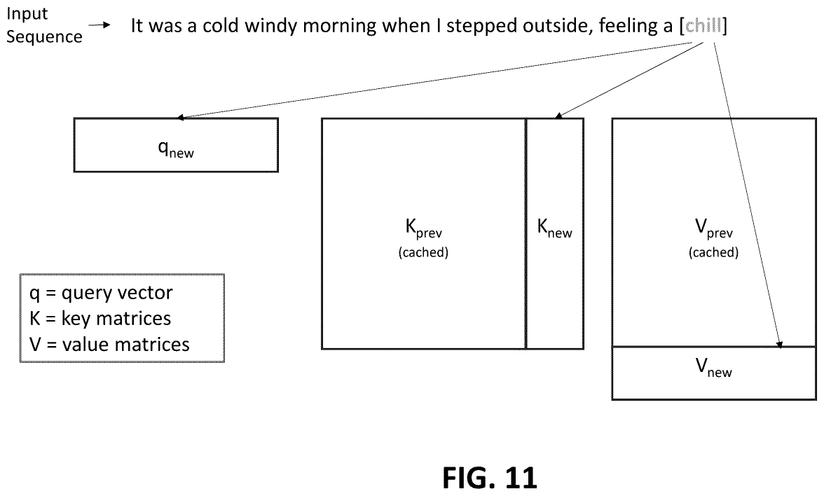

FIGS. 11, 12, and 13 depict examples of how embodiments of the invention are further operable to control interactions between pruned tokens and the key and value (KV) cache used in the self-attention layers of transformer-based implementations of the LM 510 to cache the key (K) and value (V) states of the LM 510 to thereby speed up inference operations. In accordance with embodiments of the invention, pruned tokens will not be added to the KV cache in future iterations of the layer-based generative language operations performed by the LM 510.

As shown in FIG. 11, when the LM 510 reads a new token/word it generates the query vector (represented as q_{new} in FIG. 11). The previous values for the key and value matrices are cached (represented as Kₚᵣₑᵥ and Vₚᵣₑᵥ in FIG. 11), so it is not necessary to compute the K and V vectors for the previous context. It is only necessary to compute one new column (K_{new}) for the key matrix and one new row (V_{new}) for the value matrix. Then the LM 510 can proceed with the operations to evaluate self-attention through, for example, computing attention scores.

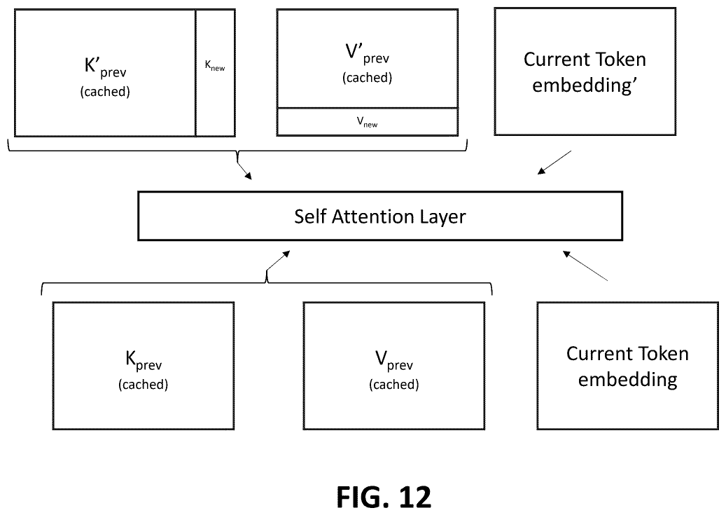

FIG. 12 illustrates how the KV cache fits in with the self-attention layer (e.g., self-attention layers (e.g., self-attention 462 shown in FIG. 4B; and self-attention 472 shown in FIG. 4C) of the transformer-based implementation of the LM 510. Instead of passing into the self-attention layer a whole sequence of K and V embeddings, only the previous K and V cache are passed into the self-attention layer, along with the embedding for the current token. The self-attention layer computes new key and value vectors for the current token, and appends them to the KV cache, as shown.

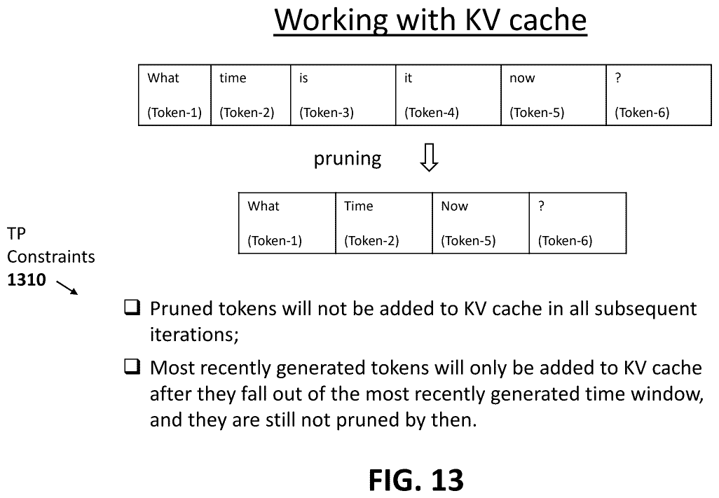

As shown in FIG. 13, additional TP constraints 1310 relevant to the management of the KV cache in the transformer-based implementation of the LM 510. TP constraints 1310 and/or TP constraints 1110 can be included, in any combination, among the TP constraints evaluated at blocks 718, 722 of the methodology 700 (shown in FIG. 7). Three (3) example TP constraints 1310 are depicted in FIG. 13. More specifically, in accordance with embodiments of the invention, pruned tokens will not be added to the KV cache in future iterations of the layer-based generative language operations performed by the LM 510. In accordance with embodiments of the invention, token importance will use absolute thresholds only to avoid a pruned token from not being pruned in subsequent iterations (due to the addition of less important tokens and a relative quantile-based threshold). In accordance with embodiments of the invention, most recently generated tokens will only be added to KV cache after they fall out of the most recently generated time window and they are still not pruned by then.

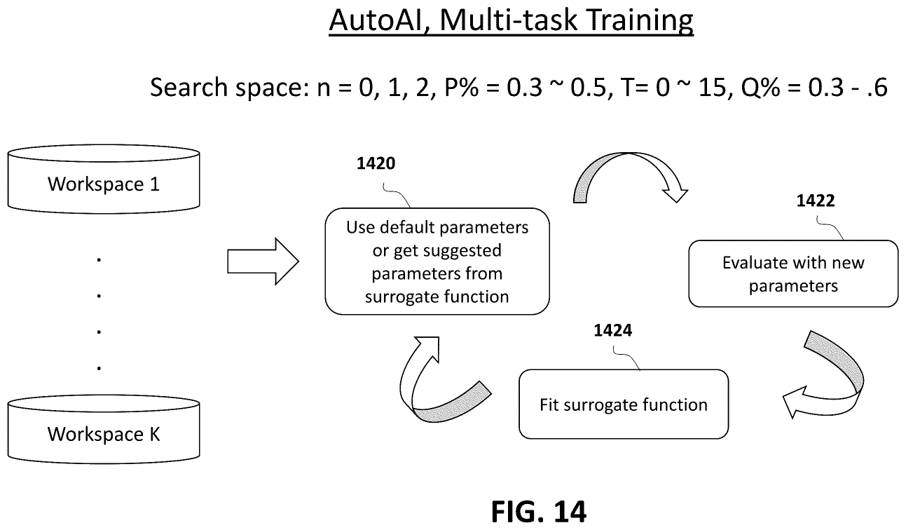

As depicted in FIG. 14, the transformer-based implementation of the LM 510 can be trained to perform the novel token pruning processes 512, 512A in accordance with the various features described herein using, for example, an automated artificial intelligence (Auto AI) system. In embodiments of the invention, the Auto AI system can be implemented using an “AutoAI” tool in Watson Studio® that is commercially available from IBM®. The IBM AutoAI tool automatically analyzes data and generates candidate model pipelines customized for predictive modeling problems. These model pipelines are created iteratively as AutoAI analyzes dataset and discovers data transformations, algorithms, and parameter settings that work best for the problem setting. Parameters are a machine learning term for the variables present in the model on which it was trained that can be used to infer new content. Results are displayed on a leaderboard, showing the automatically generated model pipelines ranked according to the problem optimization objective. The multi-task training operations depicted in FIG. 14 cycle through three operations/steps, shown at 1420, 1422, 1424. At operation 1420, default parameters are used or suggested parameters are obtained from a surrogate function. At operation 1422, new parameters are evaluated. At operation 1424, the surrogate function is fitted.

The workspaces (Workspace 1 through Workspace K, where K is a whole number) shown in FIG. 14 represent different applications/tasks (e.g., a chatbot) and the corresponding utterances the applications/tasks use the LM 510 to perform inferences. The auto AI process generally fits a function to use the configurations (n, P, T, Q in this case) and task characteristics (average length of utterances, etc.) to predict the metric of interest (for example, for chatbots, the metric of interest can be average customer rating to the generated responses). This is referred to as a surrogate function. It approximates the lengthy process of actually building a chatbot for a certain configuration and perform the inference to get the final metric. Instead, it aims to use a mathematical function to approximate how configuration affects metrics without actually conducting the experiment/inference.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method comprising:
executing, using a generative language model, generative language model operations operable to generate an output sequence responsive to an original input sequence;
wherein the generative language model operations comprise token pruning operations comprising:
performing a base set of token pruning operations on intermediate versions of the original input sequence; and
performing token pruning (TP) constraint evaluations;
wherein the base set of token pruning operations identify pruning candidate tokens in the intermediate versions of the original input sequence; and
wherein the TP constraint evaluations determine that at least one of the pruning candidate tokens will be pruned from an associated intermediate version of the original input sequence.

2. The computer-implemented method of claim 1, wherein the TP constraint evaluations determine that at least one of the pruning candidate tokens will not be pruned from the associated intermediate version of the original input sequence.

3. The computer-implemented method of claim 1, wherein:
the generative language model comprises transformer layers;
the transformer layers comprise a first transformer layer and a second transformer layer; and
the intermediate versions of the original input sequence comprises a first intermediate version of the original input sequence.

4. The computer-implemented method of claim 3, wherein the token pruning operations are applied to the first intermediate version of the original input sequence before the first intermediate version of the original input sequence is passed from the first transformer layer to the second transformer layer.

5. The computer-implemented method of claim 4, wherein the base set of token pruning operations identifying pruning candidate tokens in the intermediate versions of the original input sequence comprises determining importance level values for each token in the first intermediate version of the original input sequence.

6. The computer-implemented method of claim 5, wherein the base set of token pruning operations identifying pruning candidate tokens in the intermediate versions of the original input sequence comprises comparing the importance level values of each token in the first intermediate version of the original input sequence to an importance level threshold.

7. The computer-implemented method of claim 6, wherein the importance level value is based at least in part on an attention score.

8. A computer system comprising:
a processor system and a memory electronically coupled to the processor system, wherein the memory stores a generative language model operable to perform generative language model operations that generate an output sequence responsive to an original input sequence;
wherein the generative language model operations comprise token pruning operations comprising:
performing a base set of token pruning operations on intermediate versions of the original input sequence; and
performing token pruning (TP) constraint evaluations;
wherein the base set of token pruning operations identify pruning candidate tokens in the intermediate versions of the original input sequence; and
wherein the TP constraint evaluations determine that at least one of the pruning candidate tokens will be pruned from an associated intermediate version of the original input sequence.

9. The computer system of claim 8, wherein the TP constraint evaluations determine that at least one of the pruning candidate tokens will not be pruned from the associated intermediate version of the original input sequence.

10. The computer system of claim 8, wherein:
the generative language model comprises transformer layers;
the transformer layers comprise a first transformer layer and a second transformer layer; and
the intermediate versions of the original input sequence comprises a first intermediate version of the original input sequence.

11. The computer system of claim 10, wherein the token pruning operations are applied to the first intermediate version of the original input sequence before the first intermediate version of the original input sequence is passed from the first transformer layer to the second transformer layer.

12. The computer system of claim 11, wherein the base set of token pruning operations identifying pruning candidate tokens in the intermediate versions of the original input sequence comprises determining importance level values for each token in the first intermediate version of the original input sequence.

13. The computer system of claim 12, wherein the base set of token pruning operations identifying pruning candidate tokens in the intermediate versions of the original input sequence comprises comparing the importance level values of each token in the first intermediate version of the original input sequence to an importance level threshold.

14. The computer system of claim 13, wherein the importance level value is based at least in part on an attention score.

15. A computer program product comprising a computer readable storage medium storing a generative language model operable to perform generative language model operations that generate an output sequence responsive to an original input sequence;
wherein the generative language model operations comprise token pruning operations comprising:
performing a base set of token pruning operations on intermediate versions of the original input sequence; and
performing token pruning (TP) constraint evaluations;
wherein the base set of token pruning operations identify pruning candidate tokens in the intermediate versions of the original input sequence; and
wherein the TP constraint evaluations determine that at least one of the pruning candidate tokens will be pruned from an associated intermediate version of the original input sequence.

16. The computer program product of claim 15, wherein the TP constraint evaluations determine that at least one of the pruning candidate tokens will not be pruned from the associated intermediate version of the original input sequence.

17. The computer program product of claim 15, wherein:
the generative language model comprises transformer layers;
the transformer layers comprise a first transformer layer and a second transformer layer;
the intermediate versions of the original input sequence comprises a first intermediate version of the original input sequence; and
the token pruning operations are applied to the first intermediate version of the original input sequence before the first intermediate version of the original input sequence is passed from the first transformer layer to the second transformer layer.

18. The computer program product of claim 17, wherein the base set of token pruning operations identifying pruning candidate tokens in the intermediate versions of the original input sequence comprises determining importance level values for each token in the first intermediate version of the original input sequence.

19. The computer program product of claim 18, wherein the base set of token pruning operations identifying pruning candidate tokens in the intermediate versions of the original input sequence comprises comparing the importance level values of each token in the first intermediate version of the original input sequence to an importance level threshold.

20. The computer program product of claim 19, wherein the importance level value is based at least in part on an attention score.
